(19) United States
(12) Patent Application Publication
(10) Pub. No.: US 2020/0007339 A1
(43) Pub. Date: Jan. 2, 2020

(54) DATA TRANSMISSION METHOD, TERMINAL, AND ELECTRONIC SIGNATURE METHOD AND SYSTEM

(71) Applicant: TENDYRON CORPORATION, Beijing (CN)

(72) Inventor: Dongsheng Li, Beijing (CN)

(21) Appl. No.: 15/746,963

(22) PCT Filed: Aug. 3, 2016
(86) PCT No.: PCT/CN2016/093100

§ 371 Date: Jan. 23, 2018

(30) Foreign Application Priority Data
Aug. 4, 2015 (CN) 201510472591.7

(51) Int. Cl. H04L 9/32; H04B 5/02; H04W 76/14; H04W 4/80

(52) U.S. Cl. CPC H04L 9/3234; H04B 5/02; H04W 4/80; H04W 76/14; H04L 9/3213

(57) ABSTRACT

Provided are a data transmission method, a terminal, and an electronic signature device. The data transmission method includes: establishing an NFC connection with a terminal; sending a Bluetooth address of an electronic signature token to the terminal via the NFC connection; receiving a Bluetooth address of the terminal and first information sent by the terminal via the NFC connection; prompting the first information; performing a processing on the first information to acquire second information after the electronic signature token receives a confirming instruction for indicating that the first information is correct; broadcasting the Bluetooth address of the electronic signature token to be explored by the terminal; establishing a Bluetooth connection with the terminal corresponding to the Bluetooth address of the terminal; and sending the second information to the terminal via the Bluetooth connection.

### CROSS-REFERENCE TO RELATED APPLICATION

This application is a U.S. National phase application of an International Application No. PCT/CN2016/093100, filed on Aug. 3, 2016, which claims priority to and benefits of Chinese Patent Application Serial No. 201510472591.7, filed with the State Intellectual Property Office of P. R. China on Aug. 4, 2015, the entire content of which is incorporated herein by reference.

### FIELD

The present disclosure generally relates to the field of electronic signature, and more particularly, to a data transmission method, a terminal, an electronic signature token and a system based on Near Field Communication (NFC) technology and Bluetooth technology.

### BACKGROUND

At present, in the field of electronic signature, a connection between an electronic signature token (such as a USB key of Industrial and Commercial Bank of China, a USB key of Agricultural Bank of China, etc.) suitable for an e-bank and a terminal (such as a PC, a mobile phone, etc.) may be a wired connection via an interface including a USB interface, an audio interface and the like. The interface may be worn down due to multi-pass plugging operations, leading to a poor contact between the electronic signature token and the terminal, which may affect data transmission therebetween.

In addition, if the data transmission between the electronic signature token and the terminal is performed via Bluetooth, because of the tedious pre-connecting and pairing process of Bluetooth, the electronic signature token cannot be used quickly and conveniently, which may degrade the client experience.

### SUMMARY

The present disclosure aims to provide a data transmission method, a terminal, an electronic signature token and a system to solve at least one of the above problems. By using a combination of NFC technology and Bluetooth technology as a wireless connection, a friction loss of a wired interface and a tedious pairing process of Bluetooth may be avoided, such that data interception and monitoring may be prevented, data safety may be ensured, data transmission rate and user experience may be improved.

A main objective of embodiments of the present disclosure is to provide a data transmission method, a terminal, an electronic signature token and a system.

In order to achieve the above objectives, technical solutions of the present disclosure may be described as follows.

A first aspect of embodiments of the present disclosure provides a data transmission method. The data transmission method includes: establishing, by a terminal, an NFC connection with an electronic signature token; receiving, by the terminal, a Bluetooth address of the electronic signature token sent by the electronic signature token via the NFC connection; sending, by the terminal, a Bluetooth address of the terminal and first information to the electronic signature token via the NFC connection; performing, by the terminal, a Bluetooth address scanning to explore the Bluetooth address acquired via the NFC connection; establishing, by the terminal, a Bluetooth connection with the electronic signature token corresponding to the Bluetooth address of the electronic signature token acquired via the NFC connection; and receiving, by the terminal, second information sent by the electronic signature token via the Bluetooth connection, in which the second information is acquired by processing the first information by the electronic signature token.

A second aspect of embodiments of the present disclosure provides a data transmission method. The data transmission method includes: establishing, by an electronic signature token, an NFC connection with a terminal; sending, by the electronic signature token, a Bluetooth address of the electronic signature token to the terminal via the NFC connection; receiving, by the electronic signature token, a Bluetooth address of the terminal and first information sent by the terminal via the NFC connection; prompting the first information by the electronic signature token; performing, by the electronic signature token, a processing on the first information to acquire second information after the electronic signature token receives a confirming instruction for indicating that the first information is correct; broadcasting, by the electronic signature token, the Bluetooth address of the electronic signature token to be explored by the terminal; establishing, by the electronic signature token, a Bluetooth connection with the terminal corresponding to the Bluetooth address of the terminal; and sending, by the electronic signature token, the second information to the terminal via the Bluetooth connection.

A third aspect of embodiments of the present disclosure provides a terminal. The terminal includes: a first NFC module and a first Bluetooth module.

The first NFC module is configured to establish an NFC connection with an electronic signature token, to receive a Bluetooth address of the electronic signature token sent by the electronic signature token via the NFC connection, to send a Bluetooth address of the terminal and first information to the electronic signature token via the NFC connection, and to send the Bluetooth address of the electronic signature token to the first Bluetooth module.

The first Bluetooth module is configured to perform a Bluetooth address scanning to explore the Bluetooth address of the electronic signature token acquired via the NFC connection, to establish a Bluetooth connection with the electronic signature token corresponding to the Bluetooth address of the electronic signature token acquired via the NFC connection, to receive second information sent by the electronic signature token via the Bluetooth connection, in which the second information is acquired by processing the first information by the electronic signature token.

A fourth aspect of embodiments of the present disclosure provides an electronic signature token. The electronic signature token includes: a second NFC module, a prompting module, a confirming module, a data processing module and a second Bluetooth module.

The second NFC module is configured to establish an NFC connection with a terminal, to send a Bluetooth address of the electronic signature token to the terminal via the NFC connection, to receive a Bluetooth address of the terminal and first information sent by the terminal via the NFC connection, to send the first information to the data processing module, and to send the Bluetooth address of the terminal to the second Bluetooth module.

The prompting module is configured to display and/or to speech-play the first information.

The confirming module is configured to receive a confirming instruction, and to indicate the data processing module to perform a processing on the first information, in which the confirming instruction is configured to indicate that the first information displayed and/or speech-played by the prompting module is correct.

The data processing module is configured to perform a processing on the first information to acquire second information, and to send the second information to the second Bluetooth module.

The second Bluetooth module is configured to broadcast the Bluetooth address of the electronic signature token to be explored by the terminal, to establish a Bluetooth connection with the terminal corresponding to the Bluetooth address of the terminal, and to send the second information to the terminal via the Bluetooth connection.

A fifth aspect of embodiments of the present disclosure provides a data transmission system. The data transmission system includes the terminal and the electronic signature token described above.

A sixth aspect of embodiments of the present disclosure provides a computer readable storage medium having instructions stored thereon, in which, when the instructions are executed by a processor in a terminal, the terminal is configured to perform the data transmission method according to an embodiment of the present disclosure.

A seventh aspect of embodiments of the present disclosure provides another computer readable storage medium having instructions stored thereon, in which, when the instructions are executed by a processor in an electronic signature token, the electronic signature token is configured to perform the data transmission method according to another embodiment of the present disclosure.

### BRIEF DESCRIPTION OF THE DRAWINGS

To describe the technical solutions in the embodiments of the present disclosure more clearly, the accompanying drawings required for describing the embodiments are introduced briefly in the following. Obviously, the accompanying drawings in the following description are only some embodiments of the present disclosure, and persons of ordinary skill in the art may also derive other drawings from these accompanying drawings without creative efforts.

FIG. 1 is a structure diagram of a data transmission system according to an embodiment of the present disclosure;

FIG. 2 is a flow chart of a data transmission method according to an embodiment of the present disclosure;

FIG. 3 is a structure diagram of a terminal in a data transmission system according to an embodiment of the present disclosure;

FIG. 4 is a flow chart illustrating a process of data transmission performed by a terminal in a data transmission system according to an embodiment of the present disclosure;

FIG. 5 is a structure diagram of an electronic signature token in a data transmission system according to an embodiment of the present disclosure; and

FIG. 6 is a flow chart illustrating a process of data transmission performed by an electronic signature token in a data transmission system according to an embodiment of the present disclosure.

### DETAILED DESCRIPTION

The technical solutions in the embodiments of the present disclosure are clearly and completely described in the following with reference to the accompanying drawings in the embodiments of the present disclosure. Obviously, the embodiments in the following description are merely a part rather than all of the embodiments of the present disclosure. Based on the embodiments of the present disclosure, all other embodiments obtained by persons of ordinary skill in the art without creative efforts shall fall within the protection scope of the present disclosure.

In the description of the present disclosure, it should be noted that, unless specified or limited otherwise, the terms “mounted,” “connected,” and “coupled” and variations thereof are used broadly and encompass such as fixed or removable mountings, connections and couplings, mechanical or electrical mountings, connections and couplings, also can be direct and indirect mountings, connections, and couplings, and further can be inner mountings, connections and couplings of two components, which can be understood by persons of ordinary skill in the art according to the detail embodiment of the present disclosure.

In the following, the present disclosure will be described in detail with reference to the embodiments and the accompanying drawings.

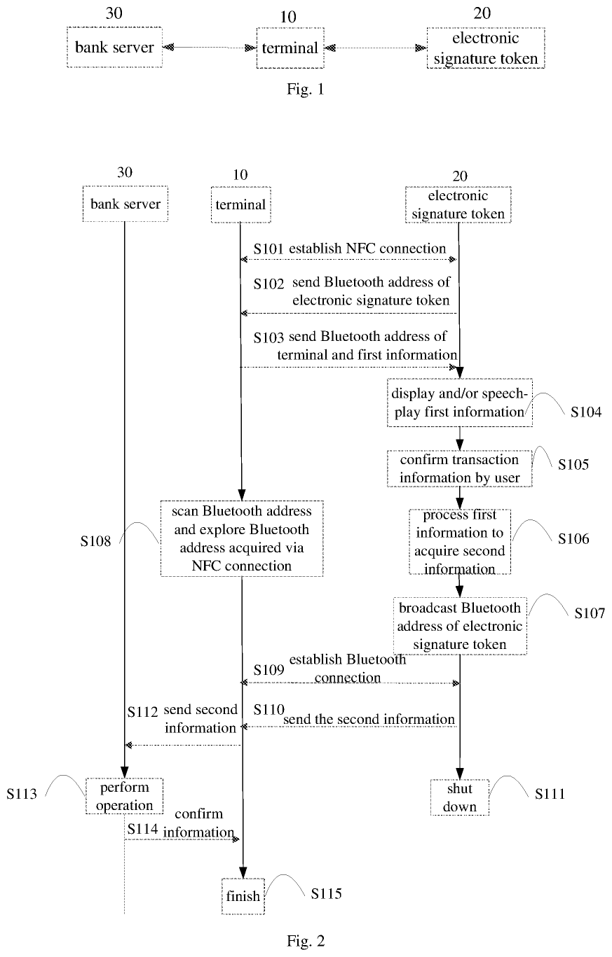

Embodiments of the present disclosure provide a data transmission system. FIG. 1 is a structure diagram of a data transmission system according to an embodiment of the present disclosure. As shown in FIG. 1, the data transmission system includes a terminal 10 and an electronic signature token 20. A data transmission may be performed between the terminal 10 and the electronic signature token 20. The data transmission includes: sending a Bluetooth address of the terminal 10 to the electronic signature token 20 by the terminal 10, sending a Bluetooth address of the electronic signature token 20 to the terminal 10 by the electronic signature token 20, sending first information to the electronic signature token 20 by the terminal 10 and sending second information acquired after a processing to the terminal 10 by the electronic signature token 20, etc.

In this embodiment, an NFC connection between the terminal 10 and the electronic signature token 20 is established, the electronic signature token 20 sends the Bluetooth address of the electronic signature token 20 to the terminal 10 via the NFC connection, and the terminal 10 sends the Bluetooth address of the terminal 10 and first information to the electronic signature token 20 via the NFC connection. The electronic signature token 20 performs a processing on the first information to acquire the second information, and broadcasts the Bluetooth address of the electronic signature token 20. The terminal 10 performs a Bluetooth address scanning to explore the Bluetooth address acquired via the NFC connection. The terminal 10 establishes a Bluetooth connection with the electronic signature token 20 corresponding to the Bluetooth address received via the NFC connection. The electronic signature token 20 sends the second information to the terminal 10 via the Bluetooth connection.

As an alternative implementation of the present disclosure, the terminal 10 may be a smart phone, a laptop computer, a tablet computer, a PC and the like. When the terminal 10 is the smart phone, the smart phone may be provided with an NFC module, through which an NFC connection with the electronic signature token can be established. In addition, smart phone on the market have the Bluetooth function, such that a Bluetooth connection and a Bluetooth communication between the electronic signature token and the smart phone can be achieved. Corresponding applications for invoking the NFC module and a Bluetooth module may be installed on the smart phone, so as to achieve the NFC connection and the Bluetooth communication between the electronic signature token and the smart phone. When the terminal 10 is the laptop computer, the tablet computer, the PC and the like, an NFC device (such as an ACR122U NFC non-contact IC card reader-writer/an inductive IC card reader-writer) may be externally connected to the laptop computer, the tablet computer, the PC and the like via a USB interface, such that the NFC connection and an NFC communication between the terminal 10 and the electronic signature token 20 can be achieved. Laptop computers on the market have the Bluetooth function, some of tablet computers on the market have the Bluetooth function but some not, while PCs on the market do not have the Bluetooth function. For the terminal without the Bluetooth function, a Bluetooth adapter or a Bluetooth bar may be externally connected to the terminal (such as the tablet computer, the PC without the Bluetooth function) via a USB interface to achieve the Bluetooth connection and the Bluetooth communication with the electronic signature token. Furthermore, corresponding client software for invoking the NFC device and the Bluetooth device may be installed on the terminal (such as the laptop computer, the tablet computer, the PC), such that the NFC connection and the Bluetooth communication between the terminal (such as the laptop computer, the tablet computer, the PC) and the electronic signature token can be achieved. Of course, the present disclosure is not limited to the above terminals, as long as a terminal is able to implement corresponding functions by cooperating with the electronic signature token, the terminal shall fall within the protection scope of the present disclosure.

As an alternative implementation of the present disclosure, the electronic signature token 20 may include products such as a USB key of Industrial and Commercial Bank of China, a USB key of Agricultural Bank of China, etc. The electronic signature token 20 may be configured with an NFC module and a Bluetooth module, such that the electronic signature token 20 may conduct a communication with the terminal via a NFC connection and a Bluetooth connection, rather than via a wired connection such as via a USB interface or an audio interface. Therefore, a friction loss of a wired interface may be avoided.

When the NFC connection between the terminal 10 and the electronic signature token 20 is needed to be established, the terminal 10 may launch an application supporting the NFC function or connect to an NFC device. When a data transmission is initiated, the terminal 10 may touch the electronic signature token 20 or put the NFC device in contact with the electronic signature token 20 according to a prompt message, such that the NFC connection between the terminal 10 and the electronic signature token 20 can be established.

As the Bluetooth address of the terminal 10 and the Bluetooth address of the electronic signature token 20 are exchanged via the NFC connection, the Bluetooth connection between the terminal 10 and the electronic signature token 20 can be established directly to perform the data transmission without Bluetooth pairing, such that user experience is improved. A process of establishing the Bluetooth connection refers to a process of connecting a Bluetooth channel, which excludes Bluetooth pairing and Bluetooth binding.

At the same time, the terminal 10 not only sends the Bluetooth address of the terminal 10 to the electronic signature token 20 via the NFC connection so as to establish the Bluetooth connection, but also sends first information to the electronic signature token 20 via the NFC connection, such that a problem of poor data transmission rate caused by performing Bluetooth pairing firstly and performing the data transmission thereafter can be avoided, and data interception and monitoring can be prevented at the same time, thereby ensuring data safety.

As an alternative implementation of the present disclosure, in a transaction process, the first information may be information to be signed. Specifically, the first information may be transaction information. The transaction information, for example, may include at least an account and an amount, and may also include transaction detail information and the like.

In addition, a display screen and/or a loudspeaker may be set for the electronic signature token 20, in which the display screen is configured to display the first information, and the loudspeaker is configured to speech-play the first information, such that a user may confirm the authenticity of the first information. Furthermore, the electronic signature token 20 may be configured with a button (a physical button or a virtual button). If the first information displayed by the electronic signature token 20 is correct, a confirming instruction may be received through the button to indicate the electronic signature token 20 to process the first information. The display screen and the button provide a double assurance for the authenticity of the information to be signed.

As an alternative implementation of the present disclosure, in a transaction process, the processing performed on the first information by the electronic signature token 20 may be a signature processing, and the acquired signature information is the second information, such that the user's identity can be authenticated, and data tampering and repudiation can be avoided.

As an alternative implementation of the present disclosure, the terminal 10 may scan the Bluetooth address in the surrounding, the electronic signature token 20 may broadcast the Bluetooth address of the electronic signature token 20. The terminal 10 may acquire a Bluetooth address list, and then determine whether the Bluetooth address of the electronic signature token 20 acquired via the NFC connection exists in the Bluetooth address list, if yes, the terminal 10 explores the Bluetooth address acquired via the NFC connection, such that the Bluetooth connection between the electronic signature token 20 and the terminal 10 is established. As the terminal 10 explores the Bluetooth address of the electronic signature token 20 and the electronic signature token 20 acquires the Bluetooth address of the terminal 10, the Bluetooth connection between the electronic signature token 20 and the terminal 10 can be established directly to perform the data transmission without Bluetooth pairing, such that the user experience is improved.

In addition, as the electronic signature token 20 sends the second information to the terminal 10 via the Bluetooth connection, the data transmission rate may be ensured. After the second information is sent, data interactions may be repeatedly performed between the electronic signature token 20 and the terminal 10 via the Bluetooth connection until all the data interactions are finished between the electronic signature token 20 and the terminal 10. Of course, the electronic signature token 20 may finish the data interactions with the terminal 10 upon sending the second information, and at this moment, after the data interactions between the electronic signature token 20 and the terminal 10 are finished, the Bluetooth connection between the electronic signature token 20 and the terminal may be disconnected automatically to ensure the safety. Once the connection is needed to be established, the terminal 10 and the electronic signature token 20 are required to transmit the Bluetooth address thereof to each other via the NFC connection again, and the Bluetooth connection is required to be established again to perform the data interactions.

After the electronic signature token 20 finishes all operations, the electronic signature token 20 may be shut down to save energy. For example, by determining that no operation is performed within a preset time period, the shut-down operation may be performed. Alternatively, the shut-down operation may be performed by receiving a shut-down instruction.

As an alternative implementation of the present disclosure, the data transmission system may further include a bank server 30. The bank server 30 is configured to receive the second information sent by the terminal 10, so as to perform a corresponding operation. For example, in a transaction process, the bank server 30 may perform an authentication on the second information after the second information is received. When the authentication is passed, operations including fund transferring, fee deduction and payment may be performed according to the transaction information.

Of course, after the bank server 30 performs the operations including fund transferring, fee deduction and payment according to the transaction information, the bank server 30 may return confirming information to the terminal 10. After the terminal 10 receives the confirming information, the terminal 10 may quit the application or shut down the NFC device to complete the transaction.

With the data transmission system provided by embodiments of the present disclosure, a terminal and an electronic signature token employ a combination of NFC technology and Bluetooth technology as the wireless connection. The usage of the wireless data transmission may avoid a friction loss of a wired interface. Bluetooth addresses may be exchanged between the terminal and the electronic signature token via an NFC connection, such that a tedious pairing process of Bluetooth can be avoided. Therefore, data interception and monitoring can be prevented, and data safety can be ensured. The processing information fed back from the electronic signature token to the terminal is transmitted via a Bluetooth mode, such that data transmission rate and user experience can be improved.

FIG. 2 is a flow chart of a data transmission method corresponding to the data transmission system provided by embodiments of the present disclosure. As shown in FIG. 2, the data transmission method may include following acts S101-S115.

At block S101, a terminal 10 establishes an NFC connection with an electronic signature token 20.

Specifically, the terminal 10 may launch an application supporting the NFC function or connect to an NFC device. When a data transmission is initiated, the terminal 10 may touch the electronic signature token 20 or put the NFC device of the terminal 10 in contact with the electronic signature token 20 according to a prompt message, such that the NFC connection between the terminal 10 and the electronic signature token 20 can be established.

At block S102, the electronic signature token 20 sends a Bluetooth address of the electronic signature token 20 to the terminal 10 via the NFC connection.

At this block, the terminal 10 acquires the Bluetooth address of the electronic signature token 20, the Bluetooth connection between the terminal 10 and the electronic signature token 20 can be established directly to perform the data transmission without Bluetooth pairing, such that the user experience is improved. A process of establishing the Bluetooth connection refers to a process of connecting a Bluetooth channel, which excludes Bluetooth pairing and Bluetooth binding.

At block S103, the terminal sends a Bluetooth address of the terminal 10 and first information to the electronic signature token 20 via the NFC connection.

Specifically, there is no certain order between block S102 and block S103, which means that block S103 may be executed before block S102. The execution sequence may be determined according to a practical situation, which will not be limited herein.

By sending the first information via the NFC connection, a problem of poor data transmission rate caused by performing Bluetooth pairing firstly and performing the data transmission thereafter can be avoided, and data interception and monitoring can be prevented at the same time, thereby ensuring data safety.

At this block, the electronic signature token 20 acquires the Bluetooth address of the terminal 10, the Bluetooth connection between the terminal 10 and the electronic signature token 20 can be established directly to perform the data transmission without Bluetooth pairing, such that the user experience is improved.

After the above blocks, the terminal 10 may move away from the electronic signature token 20, or may move away from the electronic signature token 20 according to a prompt message. In other words, the NFC connection between the electronic signature token 20 and the terminal 10 can be disconnected.

At block S104, the electronic signature token 20 displays and/or speech-plays the first information.

Specifically, a display screen and/or a loudspeaker may be set for the electronic signature token 20, in which the display screen is configured to display the first information, and the loudspeaker is configured to speech-play the first information, such that a user may confirm the authenticity of the first information. In a transaction process, the first information may be transaction information. The transaction information, for example, may include at least an account and an amount, and may also include transaction detail information and the like.

At block S105, the electronic signature token 20 receives a confirming instruction.

Specifically, the electronic signature token 20 may be configured with a button (a physical button or a virtual button). If the first information displayed and/or speech-played by the electronic signature token 20 is correct, a confirming instruction may be received through the button to indicate the electronic signature token 20 to process the first information.

By performing acts at blocks S104 and S105, the first information may be displayed on the display screen of the electronic signature token 20 and/or may be speech-played, such that the user may confirm the authenticity of the transaction, and by considering the function of the button, a double assurance is provided for the authenticity of the information to be signed.

At block S106, the electronic signature token 20 performs a processing on the first information to acquire second information.

Specifically, the processing may be signing the first information to acquire signature information as the second information.

At block S107, the electronic signature token 20 broadcasts the Bluetooth address of the electronic signature token 20.

At this block, terminals around the electronic signature token 20 can detect the electronic signature token 20, so as to establish the Bluetooth connection with the electronic signature token 20.

At block S108, the terminal 10 scans the Bluetooth address in the surrounding and explores the Bluetooth address acquired via the NFC connection.

Specifically, the terminal 10 acquires a Bluetooth address list and determines whether the Bluetooth address acquired via the NFC connection exists in the Bluetooth address list, if yes, the terminal 10 explores the Bluetooth address acquired via the NFC connection.

At block S109, a Bluetooth connection between the terminal 10 and the electronic signature token 20 is established.

Specifically, the terminal 10 explores the Bluetooth address of the electronic signature token 20 and the electronic signature token 20 acquires the Bluetooth address of the terminal 10, such that the Bluetooth connection between the terminal 10 and the electronic signature token 20 can be established directly to perform the data transmission without Bluetooth pairing, thus improving the user experience. A process of establishing the Bluetooth connection refers to a process of connecting a Bluetooth channel without Bluetooth pairing and Bluetooth binding.

In addition, block S108 is performed after block S103 and before block S109, while the execution sequence of blocks S108 and S104-S107 is not limited herein.

At block S110, the electronic signature token 20 sends the second information to the terminal 10 via the Bluetooth connection.

After the second information is sent, data interactions may be repeatedly performed between the electronic signature token 20 and the terminal 10 via the Bluetooth connection until all the data interactions are finished between the electronic signature token 20 and the terminal 10. Of course, the electronic signature token 20 may finish the data interactions with the terminal 10 upon sending the second information, and at this moment, after the data interactions between the electronic signature token 20 and the terminal 10 are finished, the Bluetooth connection between the electronic signature token 20 and the terminal may be disconnected automatically to ensure the safety. Once the connection is needed to be established, the terminal 10 and the electronic signature token 20 are required to transmit the Bluetooth address thereof to each other via the NFC connection again, and the Bluetooth connection is required to be established again to perform the data interactions.

At block S111, the electronic signature token 20 is shut down.

Of course, after the electronic signature token 20 finishes all operations, the electronic signature token 20 may be shut down to save energy.

At block S112, the terminal 10 sends the received second information to the bank server 30.

At block S113, the bank server 30 performs a corresponding operation after the second information is received.

Specifically, the bank server 30 may perform an authentication on the second information after the second information is received. When the authentication is passed, operations including fund transferring, fee deduction and payment may be performed according to the transaction information.

At block S114, the bank server 30 sends confirming information to the terminal 10.

Of course, after the bank server 30 performs the operations including fund transferring, fee deduction and payment according to the transaction information, the bank server 30 may return the confirming information to the terminal 10.

At block S115, the terminal 10 finishes the transaction.

Specifically, after the terminal 10 finishes the transaction, the terminal 10 may quit the application or shut down the NFC device.

With the data transmission system and method provided by embodiments of the present disclosure, a terminal and an electronic signature token employ a combination of NFC technology and Bluetooth technology as the wireless connection. The usage of the wireless data transmission may avoid a friction loss of a wired interface. Bluetooth addresses may be exchanged between the terminal and the electronic signature token via an NFC connection, such that a tedious pairing process of Bluetooth can be avoided. Therefore, data interception and monitoring can be prevented, and data safety can be ensured. The processing information returned from the electronic signature token to the terminal is transmitted via a Bluetooth mode, such that data transmission rate and user experience can be improved.

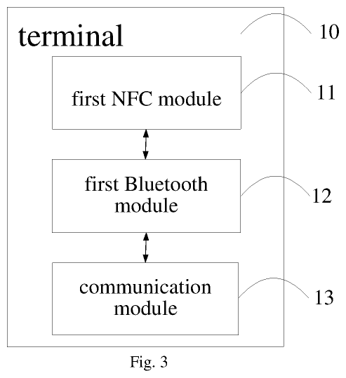

FIG. 3 is a structure diagram of a terminal of a data transmission system according to an embodiment of the present disclosure. As shown in FIG. 3, the terminal 10 may include a first NFC module 11 and a first Bluetooth module 12.

The first NFC module 11 is configured to establish an NFC connection with an electronic signature token 20. Specifically, the first NFC module 11 may be an NFC module or an NFC device. When the terminal initiates a data transmission, the terminal 10 may touch the electronic signature token 20 or put the NFC device connected to the terminal 10 in contact with the electronic signature token 20 according to a prompt message, such that the NFC connection between the terminal 10 and the electronic signature token 20 can be established.

The first NFC module 11 is further configured to receive a Bluetooth address of the electronic signature token 20 sent by the electronic signature token 20 via the NFC connection, to send a Bluetooth address of the terminal 10 and first information to the electronic signature token 20 via the NFC connection. The terminal 10 acquires the Bluetooth address of the electronic signature token 20, the Bluetooth connection between the terminal 10 and the electronic signature token 20 can be established directly to perform the data transmission without Bluetooth pairing, such that the user experience is improved. A process of establishing the Bluetooth connection refers to a process of connecting a Bluetooth channel without Bluetooth pairing and Bluetooth binding. Furthermore, the terminal 10 sends the first information to the electronic signature token 20 via the NFC connection, such that a problem of poor data transmission rate caused by performing Bluetooth pairing firstly and performing the data transmission thereafter can be avoided, and data interception and monitoring can be prevented at the same time, thereby ensuring data safety.

The first NFC module 11 is further configured to send the Bluetooth address of the electronic signature token 20 to the first Bluetooth module 12, which facilitates the first Bluetooth module 12 to perform Bluetooth address scanning.

The first Bluetooth module 12 is configured to perform a Bluetooth address scanning to explore the Bluetooth address acquired via the NFC connection, such that a Bluetooth connection between the terminal 10 and the electronic signature token 20 corresponding to the Bluetooth address acquired via the NFC connection can be established. In addition, the terminal 10 receives second information sent by the electronic signature token 20 via the Bluetooth connection, in which the second information is acquired by processing the first information by the electronic signature token 20.

With the terminal provided by embodiments of the present disclosure, a wireless mode combining NFC technology and Bluetooth technology is used to connect with the electronic signature token. The usage of the wireless data transmission may avoid a friction loss of a wired interface. Bluetooth addresses may be exchanged between the terminal and the electronic signature token via an NFC connection, such that a tedious pairing process of Bluetooth can be avoided. Therefore, data interception and monitoring can be prevented, and data safety can be ensured. The terminal receives the processing information returned from the electronic signature token to the terminal via a Bluetooth mode, such that data transmission rate and user experience can be improved.

In this embodiment, the specific process of performing the Bluetooth address scanning by the first Bluetooth module 12 and exploring the Bluetooth address acquired via the NFC connection may be described as follows: the first Bluetooth module 12 acquires the Bluetooth address list, and determines whether the Bluetooth address acquired via the NFC connection exists in the Bluetooth address list, if yes, the first Bluetooth module 12 explores the Bluetooth address acquired via the NFC connection.

In an alternative implementation of embodiments of the present disclosure, the terminal 10 may further include a communication module 13. The communication module 13 is configured to send the second information to a bank server. The bank server performs corresponding operations such as fund transferring, fee deduction and payment. With this alternative implementation, the transaction is completed.

In another alternative implementation of embodiments of the present disclosure, the first Bluetooth module 12 may be a Bluetooth low energy (BLE) module. Due to a high data transmission rate and a low power consumption of BLE technology, the data transmission between the terminal and the electronic signature token may be implemented as the high-speed and low-consumption data transmission.

With the terminal provided by embodiments of embodiments of the present disclosure, a wireless mode combining NFC technology and Bluetooth technology is used to connect with the electronic signature token. The usage of the wireless data transmission may avoid a friction loss of a wired interface. Bluetooth addresses may be exchanged between the terminal and the electronic signature token via an NFC connection, such that a tedious pairing process of Bluetooth can be avoided. Therefore, data interception and monitoring can be prevented, and data safety can be ensured. The terminal receives the processing information returned from the electronic signature token to the terminal via a Bluetooth mode, such that data transmission rate and user experience can be improved. Furthermore, when the first Bluetooth module is a BLE module, a high-speed and low-consumption transmission can be achieved.

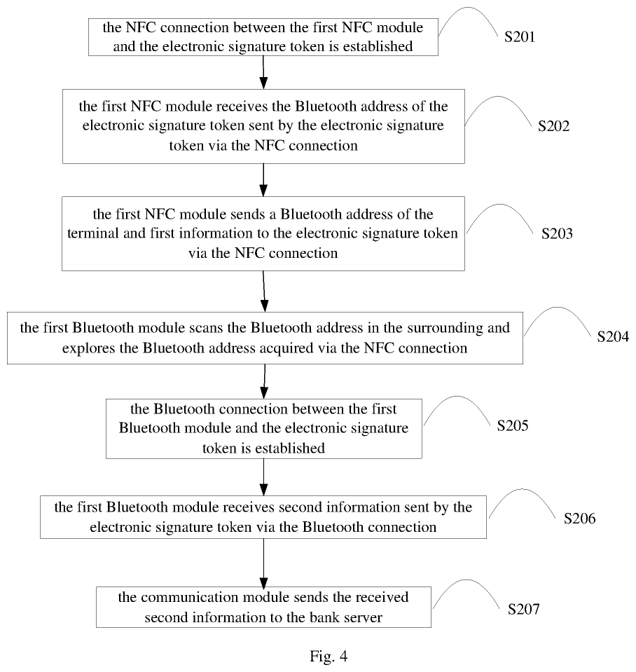

FIG. 4 is a flow chart illustrating a process of data transmission performed by a terminal in a data transmission system according to an embodiment of the present disclosure. As shown in FIG. 4, the data transmission method may include following acts S201-S207.

At block S201, the NFC connection between the first NFC module 11 and the electronic signature token 20 is established.

Specifically, the first NFC module may be an NFC module or an NFC device. When the terminal 10 initiates a data transmission, the terminal 10 may touch the electronic signature token 20 or put the NFC device in contact with the electronic signature token 20 according to a prompt message, such that the NFC connection between the first NFC module 11 and the electronic signature token 20 can be established.

At block S202, the first NFC module 11 receives the Bluetooth address of the electronic signature token 20 sent by the electronic signature token 20 via the NFC connection.

At this block, the first NFC module 11 acquires the Bluetooth address of the electronic signature token 20, the Bluetooth connection between the terminal 10 and the electronic signature token 20 can be established directly to perform the data transmission without Bluetooth pairing, such that the user experience is improved. A process of establishing the Bluetooth connection refers to a process of connecting a Bluetooth channel without Bluetooth pairing and Bluetooth binding.

At block 203, the first NFC module 11 sends a Bluetooth address of the terminal 10 and first information to the electronic signature token 20 via the NFC connection.

Specifically, there is no certain order between block S202 and block S203, which means that block S203 may be executed before block S202.

By sending the first information via the NFC connection, a problem of poor data transmission rate caused by performing Bluetooth pairing firstly and performing the data transmission thereafter can be avoided, and data interception and monitoring can be prevented at the same time, thereby ensuring data safety.

At this block, the electronic signature token 20 acquires the Bluetooth address of the terminal 10, the Bluetooth connection between the terminal 10 and the electronic signature token 20 can be established directly to perform the data transmission without Bluetooth pairing, such that the user experience can be improved.

After the above blocks, the terminal 10 may move away from the electronic signature token 20, or may move away from the electronic signature token 20 according to a prompt message. In other words, the NFC connection between the electronic signature token 20 and the terminal 10 can be disconnected.

At block S204, the first Bluetooth module 12 scans the Bluetooth address in the surrounding and explores the Bluetooth address acquired via the NFC connection.

Specifically, the first Bluetooth module 12 acquires the Bluetooth address list, and determines whether the Bluetooth address acquired via the NFC connection exists in the Bluetooth address list, if yes, the first Bluetooth module 12 explores the Bluetooth address acquired via the NFC connection.

At block S205, the Bluetooth connection between the first Bluetooth module 12 and the electronic signature token 20 is established.

Specifically, the first Bluetooth module 12 explores the Bluetooth address of the electronic signature token 20 and the electronic signature token 20 acquires the Bluetooth address of the terminal 10, such that the Bluetooth connection between the terminal 10 and the electronic signature token 20 can be established directly to perform the data transmission without Bluetooth pairing, thus improving the user experience. A process of establishing the Bluetooth connection refers to a process of connecting a Bluetooth channel without Bluetooth pairing and Bluetooth binding.

At block S206, the first Bluetooth module 12 receives second information sent by the electronic signature token 20 via the Bluetooth connection.

After the second information is sent, data interactions may be repeatedly performed between the electronic signature token 20 and the terminal 10 via the Bluetooth connection until all the data interactions are finished between the electronic signature token 20 and the terminal 10. Of course, the electronic signature token 20 may finish the data interactions with the terminal 10 upon sending the second information. After the data interactions between the electronic signature token 20 and the terminal 10 are finished, the Bluetooth connection between the electronic signature token 20 and the terminal 10 can be disconnected automatically to ensure the safety. Once the connection is needed to be established, the terminal 10 and the electronic signature token 20 are required to transmit the Bluetooth address thereof to each other via the NFC connection again, and the Bluetooth connection is required to be established to perform the data interactions.

At block S207, the communication module 13 sends the received second information to the bank server 30.

Specifically, the bank server 30 may perform an authentication on the second information after the second information is received. When the authentication is passed, operations including fund transferring, fee deduction and payment may be performed according to the transaction information. Of course, after the bank server 30 performs the operations including fund transferring, fee deduction and payment according to the transaction information, the bank server 30 may return confirming information to the terminal 10. After the terminal 10 receives the confirming information, the terminal 10 may quit the application or shut down the NFC device, such that the transaction is finished.

With the data transmission method provided by embodiments of the present disclosure, a terminal employs a combination of NFC technology and Bluetooth technology as a wireless mode to connect with an electronic signature token. The usage of the wireless data transmission may avoid a friction loss of a wired interface. Bluetooth addresses may be exchanged between the terminal and the electronic signature token via an NFC connection, such that a tedious pairing process of Bluetooth can be avoided. Therefore, data interception and monitoring can be prevented, and data safety can be ensured. The terminal receives the processing information returned from the electronic signature token to the terminal via a Bluetooth mode, such that data transmission rate and user experience can be improved.

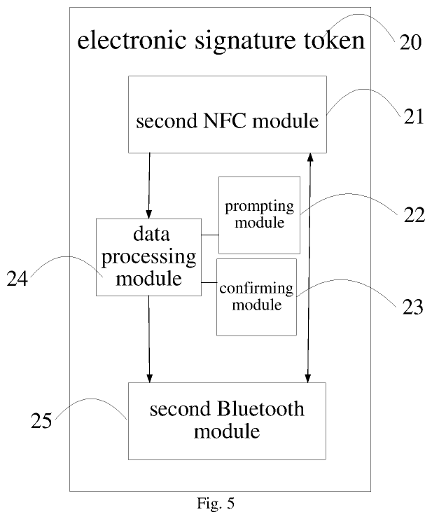

FIG. 5 is a structure diagram of an electronic signature token in a data transmission system according to an embodiment of the present disclosure. As shown in FIG. 5, the electronic signature token 20 includes a second NFC module 21, a prompting module 22, a confirming module 23, a data processing module 24 and a second Bluetooth module 25.

The second NFC module 21 is configured to establish an NFC connection with a terminal 10. Specifically, when the terminal 10 touches the electronic signature token 20, or when the electronic signature token 20 touches the NFC device of the terminal 10, the second NFC module 21 establishes the NFC connection with the terminal 10.

The second NFC module 21 is further configured to send a Bluetooth address of the electronic signature token 20 to the terminal 10 via the NFC connection, to receive a Bluetooth address of the terminal 10 and first information sent by the terminal 10 via the NFC connection, to send the first information to the data processing module 24, and to send the Bluetooth address of the terminal 10 to the second Bluetooth module 25. Bluetooth addresses may be exchanged between the terminal 10 and the electronic signature token 20, such that the Bluetooth connection between the terminal 10 and the electronic signature token 20 can be established directly to perform the data transmission without Bluetooth pairing, thus improving the user experience. A process of establishing the Bluetooth connection refers to a process of connecting a Bluetooth channel without Bluetooth pairing and Bluetooth binding. In addition, the electronic signature token 20 receives the first information sent by the terminal 10 via the NFC connection, a problem of poor data transmission rate caused by performing Bluetooth pairing firstly and performing the data transmission thereafter can be avoided effectively, and data interception and monitoring can be prevented at the same time, thereby ensuring data safety.

The prompting module 22 is configured to prompt the first information, such that the user may confirm an authenticity of the transaction.

Specifically, the prompting module 22 may be a display screen and/or a loudspeaker.

The confirming module 23 is configured to receive a confirming instruction, and to indicate the data processing module 24 to perform a processing on the first information, in which the confirming instruction is configured to indicate that the first information displayed and/or speech-played by the prompting module 22 is correct.

Specifically, the confirming module 23 may be a button. If the first information displayed and/or speech-played by the prompting module 22 is correct, a confirming instruction may be received through the button to indicate to process the first information.

With the prompting module 22 and the confirming module 23, a double assurance is provided for the authenticity of the information to be signed.

The data processing module 24 is configured to perform a processing on the first information to acquire second information. Specifically, during the processing, the first information may be signed to acquire signature information as the second information. After that, the data processing module 24 is configured to send the second information to the second Bluetooth module 25.

The second Bluetooth module 25 is configured to broadcast the Bluetooth address of the electronic signature token 20 to be explored by the terminal 10, to establish a Bluetooth connection with the terminal 10 corresponding to the Bluetooth address of the terminal 10. Therefore, the Bluetooth connection between the terminal 10 and the second Bluetooth module 25 can be established directly to perform the data transmission without Bluetooth pairing, such that the user experience is improved.

The second Bluetooth module 25 is further configured to send the second information to the terminal 10 via the Bluetooth connection to improve the data transmission rate.

With the electronic signature token provided by embodiments of the present disclosure, a wireless mode combining NFC technology and Bluetooth technology is used to connect with the terminal. The usage of the wireless data transmission may avoid a friction loss of a wired interface. Bluetooth addresses may be exchanged between the terminal and the electronic signature token via an NFC connection, such that a tedious pairing process of Bluetooth can be avoided. Therefore, data interception and monitoring can be prevented, and data safety can be ensured. The processing information fed back from the electronic signature token to the terminal is transmitted via a Bluetooth mode, such that data transmission rate and user experience can be improved.

In an alternative implementation of the present disclosure, the second Bluetooth module 25 may be a Bluetooth low energy (BLE) module. Due to a high data transmission rate and a low power consumption of BLE technology, the data transmission between the terminal and the electronic signature token may realize the high-speed and low-consumption data transmission.

With the electronic signature token provided by embodiments of the present disclosure, a wireless mode combining NFC technology and Bluetooth technology is used to connect with the terminal. The usage of the wireless data transmission may avoid a friction loss of a wired interface. Bluetooth addresses may be exchanged between the terminal and the electronic signature token via an NFC connection, such that a tedious pairing process of Bluetooth can be avoided. Therefore, data interception and monitoring can be prevented, and data safety can be ensured. The processing information returned from the electronic signature token to the terminal is transmitted via a Bluetooth mode, such that data transmission rate and user experience can be improved. Furthermore, when the second Bluetooth module is a BLE module, a high-speed and low-consumption transmission can be achieved.

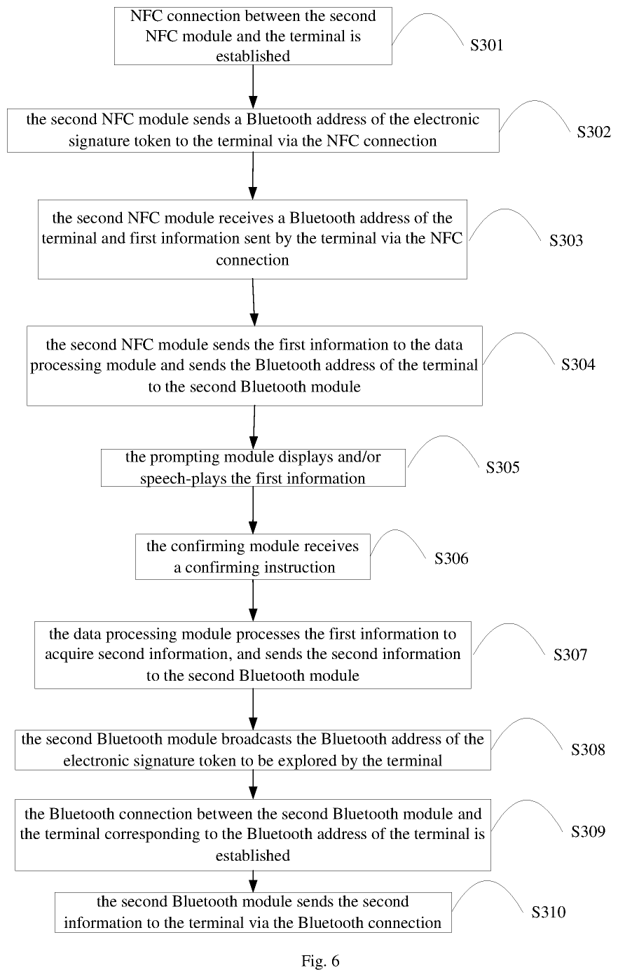

FIG. 6 is a flow chart illustrating a process of data transmission performed by an electronic signature token in a data transmission system according to an embodiment of the present disclosure. As shown in FIG. 6, the data transmission method includes following acts S301-S310.

At block S301, an NFC connection between the second NFC module 21 and the terminal 10 is established.

Specifically, when the terminal 10 touches the electronic signature token 20, or when the electronic signature token 20 touches the NFC device of the terminal 10, the second NFC module 21 establishes the NFC connection with the terminal 10.

At block S302, the second NFC module 21 sends a Bluetooth address of the electronic signature token 20 to the terminal 10 via the NFC connection.

At this block, the terminal 10 acquires the Bluetooth address of the electronic signature token 20, the Bluetooth connection between the terminal 10 and the electronic signature token 20 can be established directly to perform the data transmission without Bluetooth pairing, such that the user experience is improved. A process of establishing the Bluetooth connection refers to a process of connecting a Bluetooth channel without Bluetooth pairing and Bluetooth binding.

At block S303, the second NFC module 21 receives a Bluetooth address of the terminal 10 and first information sent by the terminal 10 via the NFC connection.

Specifically, there is no certain order between block S302 and block S303, which means that block S303 may be performed before block S302. The execution sequence may be determined according to a practical situation, which will not be limited herein.

By sending the first information via the NFC connection, a problem of poor data transmission rate caused by performing Bluetooth pairing firstly and performing the data transmission thereafter can be avoided effectively, and data interception and monitoring can be prevented at the same time, thereby ensuring data safety.

At block S304, the second NFC module 21 sends the first information to the data processing module 24 and sends the Bluetooth address of the terminal 10 to the second Bluetooth module 25.

At this block, the Bluetooth connection between the second Bluetooth module 25 and the terminal 10 can be established directly to perform the data transmission without Bluetooth pairing, such that the user experience can be improved.

At block S305, the prompting module 22 displays and/or speech-plays the first information.

Specifically, a display screen and/or a loudspeaker may be set for the prompting module 22, in which the display screen is configured to display the first information, and the loudspeaker is configured to speech-play the first information, such that a user may confirm the authenticity of the first information. In a transaction process, the first information may be transaction information. The transaction information, for example, may include at least an account and an amount, and may also include transaction detail information and the like.

At block S306, the confirming module 23 receives a confirming instruction.

Specifically, the confirming module 23 may be configured with a button (a physical button or a virtual button). If the first information displayed and/or speech-played by the prompting module 22 is correct, the confirming instruction may be received through the button to indicate the data processing module 24 to process the first information.

By performing acts at blocks S305 and S306, a double assurance is provided for the authenticity of the information to be signed.

At block S307, the data processing module 24 processes the first information to acquire second information, and sends the second information to the second Bluetooth module 25.

Specifically, during processing the first information, the first information may be signed to acquire signature information as the second information.

At block S308, the second Bluetooth module 25 broadcasts the Bluetooth address of the electronic signature token to be explored by the terminal 10.

At block S309, the Bluetooth connection between the second Bluetooth module 25 and the terminal 10 corresponding to the Bluetooth address of the terminal 10 is established.

Specifically, the terminal 10 explores the Bluetooth address of the electronic signature token 20 and the electronic signature token 20 acquires the Bluetooth address of the terminal 10, such that the Bluetooth connection between the terminal 10 and the electronic signature token 20 can be established directly to perform the data transmission without Bluetooth pairing, thus improving the user experience. A process of establishing the Bluetooth connection refers to a process of connecting a Bluetooth channel without Bluetooth pairing and Bluetooth binding.

At block S310, the second Bluetooth module 25 sends the second information to the terminal 10 via the Bluetooth connection.

After the second information is sent, data interactions may be repeatedly performed between the electronic signature token 20 and the terminal 10 via the Bluetooth connection until all the data interactions are finished between the electronic signature token 20 and the terminal 10. Of course, the electronic signature token 20 may finish the data interactions with the terminal 10 upon sending the second information. After the data interactions between the electronic signature token 20 and the terminal 10 are finished, the Bluetooth connection between the electronic signature token 20 and the terminal 10 can be disconnected automatically to ensure the safety. Once the connection is needed to be established, the terminal 10 and the electronic signature token 20 are required to transmit the Bluetooth address thereof to each other via the NFC connection again, and the Bluetooth connection is required to be established to perform the data interactions.

With the data transmission method provided by embodiments of the present disclosure, the electronic signature token employs a combination of NFC technology and Bluetooth technology as a wireless mode to connect with the terminal. The usage of the wireless data transmission may avoid a friction loss of a wired interface. Bluetooth addresses may be exchanged between the terminal and the electronic signature token via an NFC connection, such that a tedious pairing process of Bluetooth can be avoided. Therefore, data interception and monitoring can be prevented, and data safety can be ensured. The processing information returned from the electronic signature token to the terminal is transmitted via a Bluetooth mode, such that data transmission rate and user experience can be improved.

Embodiments of the present disclosure also provide a computer readable storage medium having instructions stored thereon, in which, when the instructions are executed by a processor in a terminal, the terminal is configured to perform the data transmission method according to an embodiment of the present disclosure.

Embodiments of the present disclosure also provide another computer readable storage medium having instructions stored thereon, in which, when the instructions are executed by a processor in an electronic signature token, the electronic signature token is configured to perform the data transmission method according to another embodiment of the present disclosure.

In should be noted that, in this description, relation terms such as first and second and the like is merely used to distinguish an object or operation from another object or operation, and it is not necessary to require or imply that there is any real relations or order among these objects or operations. Furthermore, terms “comprise”, “include” or any other modifications are aim at covering non-exclusive “include”, such that a process, a method, a term or a device including a series of elements also includes other elements which are not listed definitely. Without further limitation, an element defined by a sentence “include a . . . ” may not exclusive of other same elements included in the process, the method, the term or the device including the said element.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

In the description of the specification, reference terms including “an embodiment,” “some embodiments,” “an example,” “a specific example,” or “some examples,” means that a particular structure, feature, material, or characteristic described in connection with the embodiment or example is included in at least one embodiment or example of the present disclosure. In this specification, the appearances of the phrases of above terms are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by persons of ordinary skill in the art that the above embodiments cannot be construed to limit the present disclosure, and changes, alternatives, and modifications can be made in the embodiments without departing from scope of the present disclosure.

1-3. (canceled)

4. A data transmission method, comprising:
establishing, by an electronic signature token, an NFC connection with a terminal;
sending, by the electronic signature token, a Bluetooth address of the electronic signature token to the terminal via the NFC connection;
receiving, by the electronic signature token, a Bluetooth address of the terminal and first information sent by the terminal via the NFC connection;
prompting, by the electronic signature token, the first information;
performing, by the electronic signature token, a processing on the first information to acquire second information after the electronic signature token receives a confirming instruction for indicating that the first information is correct;
broadcasting, by the electronic signature token, the Bluetooth address of the electronic signature token to be explored by the terminal;
establishing, by the electronic signature token, a Bluetooth connection with the terminal corresponding to the Bluetooth address of the terminal; and
sending, by the electronic signature token, the second information to the terminal via the Bluetooth connection.

5. The data transmission method according to claim 4, wherein the first information comprises information to be signed, the processing performed on the first information by the electronic signature token comprises a signature processing, and the second information comprises signature information.

6. A terminal, comprising:
a first NFC module; and
a first Bluetooth module, wherein,
the first NFC module is configured to establish an NFC connection with an electronic signature token, to receive a Bluetooth address of the electronic signature token sent by the electronic signature token via the NFC connection, to send a Bluetooth address of the terminal and first information to the electronic signature token via the NFC connection, and to send the Bluetooth address of the electronic signature token to the first Bluetooth module; and
the first Bluetooth module is configured to perform a Bluetooth address scanning to explore the Bluetooth address of the electronic signature token acquired via the NFC connection, to establish a Bluetooth connection with the electronic signature token corresponding to the Bluetooth address of the electronic signature token acquired via the NFC connection, to receive second information sent by the electronic signature token via the Bluetooth connection, in which the second information is acquired by performing a processing on the first information by the electronic signature token.

7. The terminal according to claim 6, wherein,
the first Bluetooth module is configured to acquire a Bluetooth address list, and to determine whether there is the Bluetooth address of the electronic signature token acquired via the NFC connection in the Bluetooth address list, and to explore the Bluetooth address of the electronic signature token acquired via the NFC connection if there is the Bluetooth address of the electronic signature token acquired via the NFC connection in the Bluetooth address list.

8. The terminal according to claim 6, further comprising:
a communication module, configured to send the second information to a bank server.

9. The terminal according to claim 6, wherein the first information comprises information to be signed, and the second information comprises signature information.

10. An electronic signature token, comprising:
a second NFC module,
a prompting module,
a confirming module,
a data processing module and
a second Bluetooth module, wherein,
the second NFC module is configured to establish an NFC connection with a terminal, to send a Bluetooth address of the electronic signature token to the terminal via the NFC connection, to receive a Bluetooth address of the terminal and first information sent by the terminal via the NFC connection, to send the first information to the data processing module, and to send the Bluetooth address of the terminal to the second Bluetooth module;
the prompting module is configured to display and/or to speech-play the first information;
the confirming module is configured to receive a confirming instruction, and to indicate the data processing module to perform a processing on the first information, in which the confirming instruction is configured to indicate that the first information displayed and/or speech-played by the prompting module is correct;
the data processing module is configured to perform a processing on the first information to acquire second information, and to send the second information to the second Bluetooth module; and
the second Bluetooth module is configured to broadcast the Bluetooth address of the electronic signature token to be explored by the terminal, to establish a Bluetooth connection with the terminal corresponding to the Bluetooth address of the terminal, and to send the second information to the terminal via the Bluetooth connection.

11. The electronic signature token according to claim 10, wherein the first information comprises information to be signed, the processing performed by the data processing module comprises a signature processing, and the second information comprises signature information.

12-15. (canceled)

16. The terminal according to claim 7, wherein the first information comprises information to be signed, and the second information comprises signature information.

17. The terminal according to claim 8, wherein the first information comprises information to be signed, and the second information comprises signature information.
